(19) United States
(12) Patent Application Publication
(10) Pub. No.: US 2026/0146837 A1
(43) Pub. Date: May 28, 2026

(54) MEASUREMENT TOOL AND SYSTEM

(71) Applicant: GM GLOBAL TECHNOLOGY OPERATIONS LLV, Detroit, MI (US)

(72) Inventors: David J. Plozai, Livonia, MI (US); Wei Wu, Troy, MI (US); Charles M. Dikos, Swartz Creek, MI (US); Christopher J. Stark, Sterling Heights, MI (US)

(73) Assignee: GM GLOBAL TECHNOLOGY OPERATIONS LLC, Detroit, MI (US)

(21) Appl. No.: 18/958,117

(22) Filed: Nov. 25, 2024

(51) Int. Cl. G01B 5/06; G01B 3/20; G01B 11/06

(52) U.S. Cl. CPC G01B 5/065; G01B 3/20; G01B 11/0608

(57) ABSTRACT

A measurement tool includes a C-shaped body including a first arm having a first end; a second arm spaced apart from and disposed substantially parallel to the first arm; and a third arm connecting and disposed substantially perpendicular to the first arm and the second arm to thereby define a void between the first arm and the second arm. The measurement tool also includes a fourth arm connected to the C-shaped body at the first end and disposed substantially perpendicular to both the first arm and the third arm. A measurement system includes the measurement tool and a workpiece disposed within the void between the first arm and the second arm.

### INTRODUCTION

The disclosure relates to a measurement tool and system.

Workpieces, such as those formed from metal or molded from plastic or composites, may include multiple regions having different thicknesses. Such thicknesses may be measured at various locations along the workpiece with measurement devices such as, for example, micrometers, calipers, and displacement sensors. During prototype formation and research and development activities, such measurements may provide valuable information regarding metal forming processes, injection molding operations, and the like.

### SUMMARY

A measurement tool includes a C-shaped body including a first arm having a first end and a second arm spaced apart from and disposed substantially parallel to the first arm. The C-shaped body also includes a third arm connecting and disposed substantially perpendicular to the first arm and the second arm to thereby define a void between the first arm and the second arm. The measurement tool further includes a fourth arm connected to the C-shaped body at the first end and disposed substantially perpendicular to both the first arm and the third arm.

In one aspect, the measurement tool may further include a plurality of support blocks each spaced apart from the first arm.

In an additional aspect, the plurality of support blocks may be repositionable adjacent the first arm and configured to support a workpiece disposed within the void.

In another aspect, the plurality of support blocks may be disposed on opposite sides of the first arm.

In a further aspect, the second arm may have a second end spaced apart from the first end and the third arm.

In one aspect, the first end and the second end may each be configured for attaching to a calibrated measurement device.

In an additional aspect, the first arm may be spaced apart from the second arm by from 5 mm to 100 mm.

In another aspect, the first arm, the second arm, the third arm, and the fourth arm may be integrally formed.

A measurement system includes a measurement tool including a C-shaped body. The C-shaped body includes a first arm having a first end and a second arm spaced apart from and disposed substantially parallel to the first arm. The C-shaped body also includes a third arm connecting and disposed substantially perpendicular to the first arm and the second arm to thereby define a void between the first arm and the second arm. The measurement tool also includes a fourth arm connected to the C-shaped body at the first end and disposed substantially perpendicular to both the first arm and the third arm. The measurement system further includes a workpiece disposed within the void between the first arm and the second arm.

In one aspect, the workpiece may have a thickness of from 1 mm to 100 mm.

In an additional aspect, the workpiece may have a width of from 1 mm to 700 mm.

In another aspect, the measurement system may further include a plurality of support blocks each spaced apart from the first arm.

In a further aspect, the plurality of support blocks may be disposed on opposite sides of the first arm.

In one aspect, the workpiece may rest upon and be supported by the plurality of support blocks.

In an additional aspect, the first end may be spaced apart from the third arm and the second arm may have a second end spaced apart from the first end.

In another aspect, the measurement system may further include a caliper measurement device attached to the first end and the second end and configured for measuring a thickness of the workpiece.

In an additional aspect, the workpiece may be repositionable within the void such that the caliper measurement device is configured for measuring the thickness of the workpiece in a plurality of locations on the workpiece.

In another aspect, a vehicle may include the workpiece of the measurement system.

In another embodiment, a measurement system includes a measurement tool including a C-shaped body. The C-shaped body includes a first arm having a first end and a second arm spaced apart from and disposed substantially parallel to the first arm, wherein the second arm has a second end spaced apart from the first end. The C-shaped body also includes a third arm connecting and disposed substantially perpendicular to the first arm and the second arm to thereby define a void between the first arm and the second arm. The measurement tool further includes a fourth arm connected to the C-shaped body at the first end and disposed substantially perpendicular to both the first arm and the third arm, an extension member attached to the second end and configured for extending a length of the second arm, and a receptacle defining a pocket and attached to the fourth arm. The measurement system also includes a workpiece disposed within the void between the first arm and the second arm.

In one aspect, the measurement system may further include at least one calibrated laser measurement device configured for measuring a thickness of the workpiece. The at least one calibrated laser measurement device may be attached to the extension member or disposed within the pocket. The workpiece may be repositionable within the void such that the at least one calibrated laser measurement device is configured for measuring the thickness of the workpiece in a plurality of locations on the workpiece.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of an isometric view of a measurement tool.

FIG. 2 is a schematic illustration of an isometric view of a caliper measurement device attached to the measurement tool of FIG. 1.

FIG. 3 is a schematic illustration of an isometric view of a measurement system including a workpiece disposed between a first arm and a second arm of the measurement tool of FIG. 1.

FIG. 4 is a schematic illustration of an isometric view of another embodiment of the measurement tool of FIG. 1.

FIG. 5 is a schematic illustration of a perspective, underside view of another embodiment of the measurement system of FIG. 3, which includes a calibrated laser measurement device attached to the measurement tool of FIG. 4.

FIG. 6 is a schematic illustration of a perspective view of a vehicle including the workpiece of FIG. 3.

### DETAILED DESCRIPTION

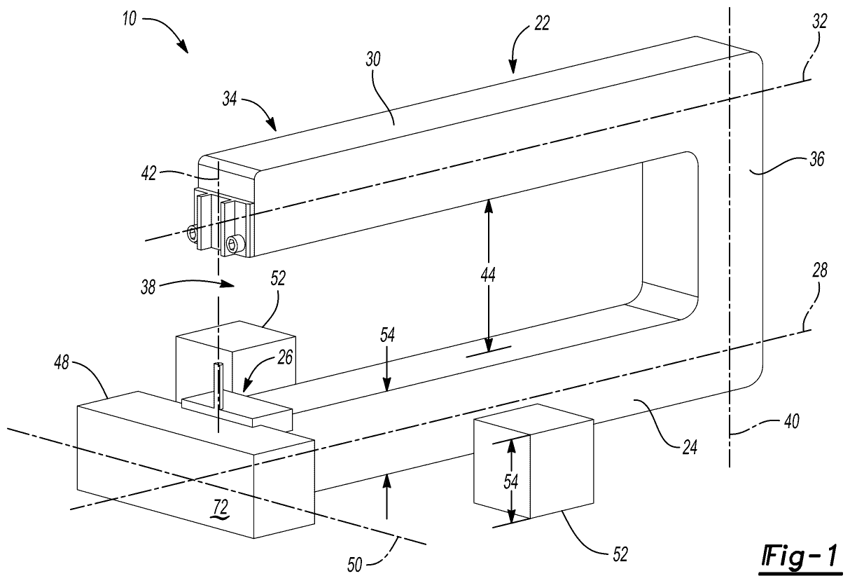

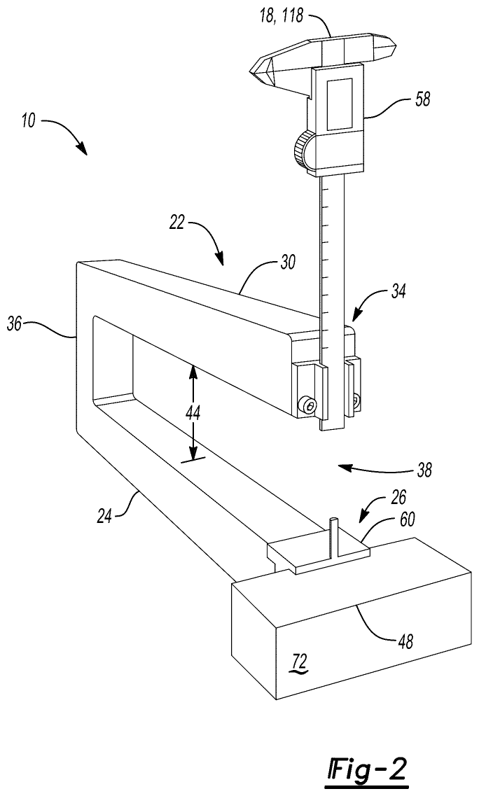

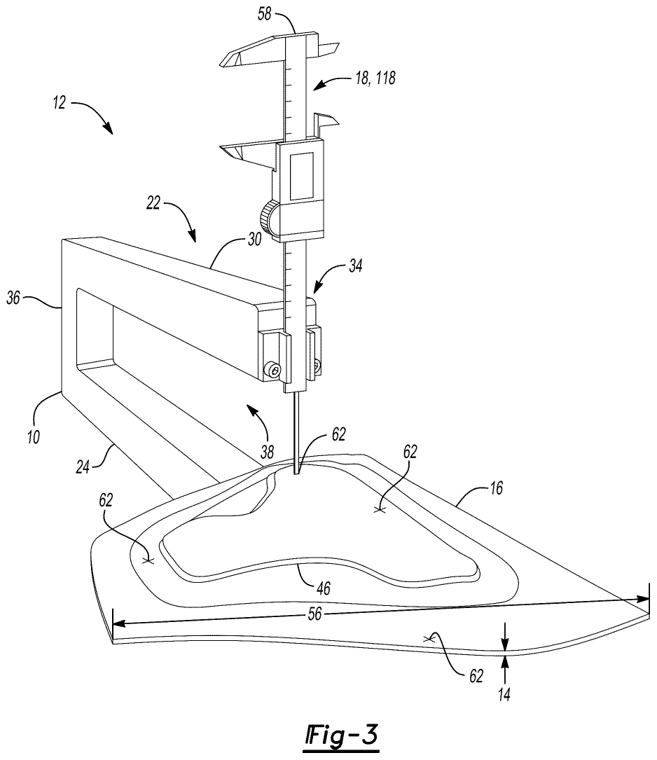

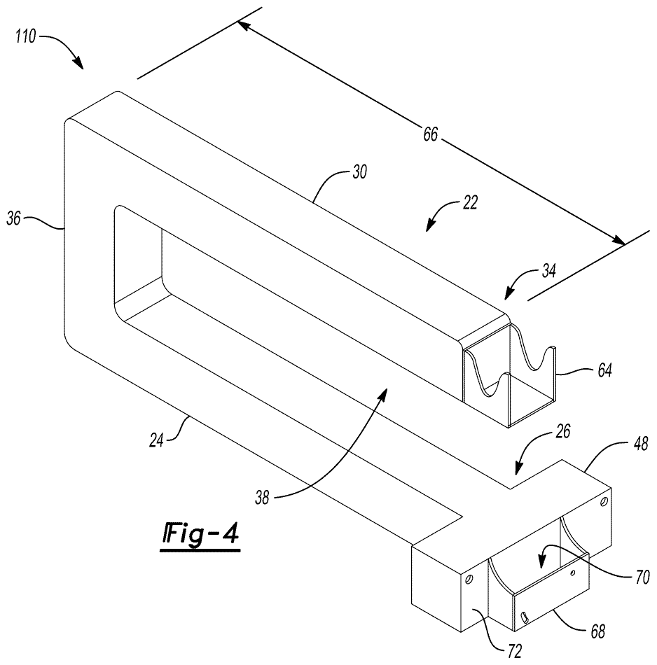

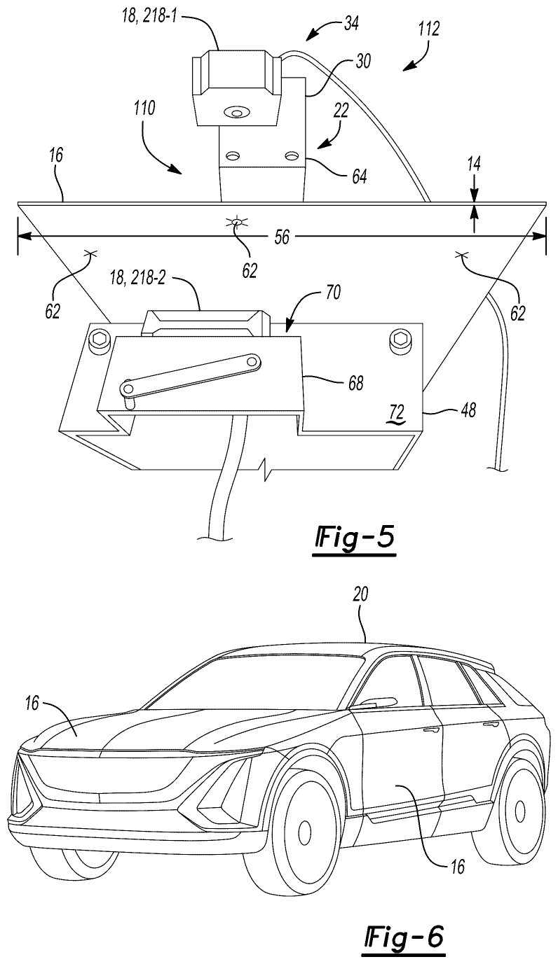

Referring to the Figures, wherein like reference numerals refer to like elements, a measurement tool 10, 110 (FIGS. 1 and 4) and a measurement system 12, 112 (FIGS. 3 and 5) are shown generally. The measurement tool 10, 110 and measurement system 12, 112 may be useful for applications requiring accurate measurement of a thickness 14 (FIGS. 3 and 5) of a workpiece 16 (FIGS. 3 and 5). In particular, the measurement tool 10, 110 and measurement system 12, 112 may be useful for quickly, easily, and precisely measuring various thicknesses 14 across an entirety of the workpiece 16 for workpieces 16 formed from metals and nonmetals, such as plastics and composites. More specifically, and as set forth in more detail below, the measurement tool 10, 110 and measurement system 12, 112 may be compatible with various calibrated measurement devices 18 (FIGS. 2 and 5) such as, for example, a caliper measurement device 118 (FIG. 2), a calibrated laser measurement device 218-1 (FIG. 5), an ultrasonic device (not shown), and the like, and may allow the workpiece 16 to be quickly and easily repositioned during measurement without extensive retooling and recalibration.

The measurement tool 10, 110 and measurement system 12, 112 may be useful for measuring the thickness 14 of workpieces 16 formed from various materials and having various sizes and shapes. By way of non-limiting examples, the workpiece 16 may be formed from metal, wood, ceramic, plastic, composite, alloys, and the like, and may have any color, including black. As such, the measurement tool 10, 110 and measurement system 12, 112 may not be limited to optically measuring the thickness 14 of the workpiece 16 or measuring the thickness 14 via contact with the workpiece 16. Further, the workpiece 16 may be in sheet form, stamped, formed, molded, or otherwise processed and may include one more protrusions 46 (FIG. 3), as set forth in more detail below.

In one example, the measurement tool 10, 110 and measurement system 12, 112 may be useful for measuring the thickness 14 of workpieces 16 for automotive applications such as, but not limited to, vehicles 20 (FIG. 6) including internal combustion engine vehicles, electric vehicles, hybrid vehicles, and the like. For example, the vehicle 20 may be a motor vehicle powered by a motive power source including at least one of an internal combustion engine, an electric motor, and an energy storage device, and the vehicle 20 may include the workpiece 16 of the measurement system 12, 112. By way of non-limiting examples, the workpiece 16 may be a metal, plastic, or composite body component that is visible to a driver such as, but not limited to, a door panel, a trunk lid, a body panel, and the like, or may be a metal, plastic, or composite component of the vehicle 20 that is less visible to a driver, such as a skid plate, a housing, ductwork, and the like.

Further, the vehicle 20 may be configured for autonomous or automated driving in which the vehicle 20 may be controlled or driven by technology including hardware and software, whether remote to the vehicle 20 or onboard the vehicle 20, that is capable of driving the vehicle 20 without active physical control by a human operator. For example, autonomous or automated driving tasks may include, but are not limited to, object and event detection, recognition, and classification; object and event response; maneuver planning; steering, turning, lane-keeping, signaling, and lane changing; and acceleration and deceleration.

Alternatively, the measurement tool 10, 110, measurement system 12, 112, and vehicle 20 may be useful for measurement processes for non-automotive applications such as, but not limited to, aerospace, aviation, marine, mass transportation, agricultural, industrial, and rail applications. For example, the vehicle 20 may be, but is not limited to, a commercial vehicle, industrial vehicle, passenger vehicle, aircraft, watercraft, train, trolley, bus, or the like. It is also contemplated that the vehicle 20 may be a mobile platform, such as an airplane, all-terrain vehicle (ATV), boat, personal movement apparatus, robot, and the like to accomplish the purposes of this disclosure.

Referring now to FIG. 1, the measurement tool 10 includes a C-shaped body 22 including a first arm 24 having a first end 26. That is, the first arm 24 may be one portion of the C-shaped body 22 and may extend along a first longitudinal axis 28 to form a base of the C-shaped body 22. As best shown in FIG. 2 and set forth in more detail below, the first end 26 of the first arm 24 may be configured for accepting or connecting to a portion of the calibrated measurement device 18.

Referring again to FIG. 1, the C-shaped body 22 also includes a second arm 30 spaced apart from and disposed substantially parallel to the first arm 24. That is, the second arm 30 may be another portion of the C-shaped body 22 and may extend along a second longitudinal axis 32 that is substantially parallel to the first longitudinal axis 28 to form an upper part of the C-shaped body 22. Further, the second arm 30 may have a second end 34 spaced apart from the first end 26. As such, as described with reference to FIG. 2, the second end 34 may also be configured for accepting or connecting to another portion of the calibrated measurement device 18. That is, the first end 26 and the second end 34 may each be configured for attaching to and supporting the calibrated measurement device 18 as set forth in more detail below.

As shown in FIG. 1, the C-shaped body 22 also includes a third arm 36 connecting and disposed substantially perpendicular to the first arm 24 and the second arm 30 to thereby define a void 38 between the first arm 24 and the second arm 30. That is, the third arm 36 may be an additional portion of the C-shaped body 22 and may extend along a first latitudinal axis 40 that is substantially perpendicular to the first longitudinal axis 28 and the second longitudinal axis 32 to form a latitudinal part of the C-shaped body 22 and space the second arm 30 apart from the first arm 24.

As also shown in FIG. 1, the second end 34 of the second arm 30 may also be spaced apart from the third arm 36 along the second longitudinal axis 32. That is, the second end 34 may be spaced apart from both the first end 26, i.e., across the void 38 along a second latitudinal axis 42 that is substantially parallel to the first latitudinal axis 40, and the third arm 36, i.e., along the second longitudinal axis 32. Likewise, the first end 26 of the first arm 24 may also be spaced apart from the third arm 36.

As a non-limiting example, and as described with continued reference to FIG. 1, the void 38 may have a height 44 of from 5 mm to 100 mm. That is, the first arm 24 may be spaced apart from the second arm 30 by up to 100 mm, e.g., from 5 mm to 100 mm, or from 5 mm to 75 mm, or from 5 mm to 60 mm. As such, the workpiece 16 may have a thickness 14 of from 1 mm to 100 mm and the void 38 may accept workpieces 16 with comparatively deep stampings. Therefore, workpieces 16 (FIG. 3) having thicknesses 14 of up to 100 mm may fit and be repositionable within the void 38. Such an ample height 44 of the void 38 may allow for easy and precise measurements for comparatively large workpieces 16 having varying thicknesses 14, such as formed metal sheets or other non-metal parts having stamped or molded or protrusions (shown generally at 46 in FIG. 3).

Therefore, the C-shaped body 22 that defines the void 38 may simultaneously provide the measurement tool 10, 110 and measurement system 12, 112 with a stable base to support the calibrated measurement device 18 and workpiece 16 and flexibility to quickly reposition the workpiece 16 within the void 38.

Referring again to FIG. 1, the measurement tool 10 also includes a fourth arm 48 connected to the C-shaped body 22 at the first end 26 and disposed substantially perpendicular to both the first arm 24 and the third arm 36. That is, the fourth arm 48 may be another portion of the measurement tool 10 and may extend along a fourth longitudinal axis 50 that is substantially perpendicular to the first longitudinal axis 28, the second longitudinal axis 32, and the first latitudinal axis 40 to form another support portion of the measurement tool 10. In particular, the fourth arm 48 may provide lateral support to the first arm 24 to provide the measurement tool 10 with stability. Further, the first arm 24, the second arm 30, the third arm 36, and the fourth arm 48 may be integrally formed, for example, from a metal such as steel. That is, each of the arms 24, 30, 36, 48 of the measurement tool 10 may be integral such that the C-shaped body 22 and the fourth arm 48 are a single piece or one component.

As described with continued reference to FIG. 1, the measurement tool 10 may further include a plurality of support blocks 52 each spaced apart from the first arm 24. Each of the plurality of support blocks 52 may have a height 54 equal to the height 54 of the first arm 24 and may be arranged such that the workpiece 16 rests upon the plurality of support blocks 52 while the thickness 14 of the workpiece 16 is measured. For example, the measurement tool 10 may include two support blocks 52 and the support blocks 52 may be disposed on opposite sides of the first arm 24. Further, the plurality of support blocks 52 may be repositionable adjacent the first arm 24 and may be configured to support the workpiece 16 disposed within the void 38. Stated differently, the workpiece 16 may rest upon and be supported by the plurality of support blocks 52 such that the support blocks 52 may provide lateral support for comparatively large or wide workpieces 16 disposed within the void 38 of the measurement tool 10.

Referring now to FIG. 3, the measurement system 12 includes the measurement tool 10 and the workpiece 16 disposed within the void 38 between the first arm 24 and the second arm 30. That is, the workpiece 16 may be positioned within the void 38 of the C-shaped body 22 defined by the first arm 24, the second arm 30, and the third arm 36. While the workpiece 16 may have the thickness 14 of from 1 mm to 100 mm as set forth above, the workpiece 16 may have a width 56 of from 1 mm to 700 mm. That is, since the measurement tool 10 may include the plurality of support blocks 52 as set forth above, the measurement system 12 may support a comparatively wide workpiece 16.

Referring now to FIGS. 2 and 3, the measurement system 12 may include the caliper measurement device 118 attached to the first end 26 and the second end 34 and configured for measuring the thickness 14 of the workpiece 16. For example, the caliper measurement device 118 may have an upper caliper portion 58 attached to the second end 34 and a lower caliper portion 60 attached to the first end 26. In one non-limiting example, the caliper measurement device 118 may be a Vernier caliper device that includes calipers that are movable or slidable with respect to one another and a dual measurement scale designed for precise measurements. The Vernier caliper device may provide a quick, on-the-fly, tangible thickness 14 measurement without a need for software calibrations, resolution adjustments, and the like.

In other non-limiting examples, the C-shaped body 22 may be configured to receive and attach to various types of calibrated measurement devices 18. That is, advantageously, one calibrated measurement device 18 may be quickly and conveniently exchanged for another calibrated measurement device 18 by simply attaching the desired calibrated measurement device 18 to the C-shaped body 22 at the first end 26 and the second end 34. As such, thickness 14 measurements may be obtained on-the-fly without extensive recalibration of measurement devices between measurements, thereby saving cost and time while accurately measuring the thickness 14 of the workpiece 16.

Advantageously, the workpiece 16 may be repositionable within the void 38 such that the caliper measurement device 118 may be configured for measuring the thickness 14 of the workpiece 16 in a plurality of locations 62 (FIG. 3) on the workpiece 16. That is, the workpiece 16 may be easily repositioned within the void 38 to obtain a plurality of thicknesses 14 measurements along the workpiece 16 and thereby develop a map of the topography of the workpiece 16. Stated differently, the measurement tool 10, 110 and measurement system 12, 112 may not require the workpiece 16 to be rigidly mounted to the C-shaped body 22. Rather, the workpiece 16 may be repeatedly manually repositioned within the void 38 by sliding or translating the workpiece 16 back and forth and side to side within the void 38. Such agile repositioning capability allows a user to quickly and conveniently obtain multiple thickness 14 measurements across an entire surface of the workpiece 16.

Referring now to FIGS. 4 and 5, in another embodiment, the measurement system 112 includes the measurement tool 110 having an extension member 64 attached to the second end 34 and configured for extending a length 66 (FIG. 4) of the second arm 30. In addition, as best shown in FIG. 4, the measurement tool 110 includes a receptacle 68 defining a pocket 70 and attached to the fourth arm 48. For example, the receptacle 68 may be disposed on a front face 72 of the fourth arm 48.

For this embodiment, the measurement system 112 may further include at least one calibrated laser measurement device 218-1, i.e., a first calibrated laser measurement device 218-1, configured for measuring the thickness 14 of the workpiece 16. More specifically, the first calibrated laser measurement device 218-1 may be attached to the extension member 64 or disposed within the pocket 70. For example, as best shown in FIG. 5, the first calibrated laser measurement device 218-1 may be a laser distance meter that includes a laser generator attached to the extension member 64 and configured for generating a pulse of laser light toward the workpiece 16. The pulse of laser light may be reflected off the workpiece 16 toward a receiver or sensor or eye and the first calibrated laser measurement device 218-1 may calculate a distance from the laser generator to the workpiece 16 based on a time required for the pulse of laser light to return to the receiver.

Similarly, a second calibrated laser measurement device 218-2 may be disposed within the pocket 70 and aligned with the first calibrated laser measurement device 218-1 attached to the extension member 64. The second calibrated laser measurement device 218-2 may similarly measure the distance between an underside of the workpiece 16 and the second calibrated laser measurement device 218-2. A comparison of the two distances with respect to an overall distance between the first calibrated measurement device 218-1 and the second calibrated laser measurement device 218-2 may yield the thickness 14 of the workpiece 16 for a given location 62 on the workpiece 16. The workpiece 16 may then be repositioned within the void 38 to quickly and accurately obtain additional thickness 14 measurements in other locations 62 on the workpiece 16. That is, the workpiece 16 may be repositionable within the void 38 such that the at least one calibrated laser measurement device 218-1 is configured for measuring the thickness 14 of the workpiece 16 in a plurality of locations 62 on the workpiece 16.

Beneficially, the calibrated laser measurement device 218-1 may not require physical contact with the workpiece 16 during thickness 14 measurement, which may enhance an accuracy of the measurement. In addition, since the calibrated laser measurement device 218-1 requires a comparatively small footprint or window on a surface of the workpiece 16 upon which to reflect the pulse of laser light, the laser measurement device 218-1 may be suitable for protrusions 46 (FIG. 3) having small radii of curvature.

Therefore, in summary, the measurement tool 10, 110 and measurement system 12, 112 may be useful for quickly, easily, and accurately measuring the thickness 14 of the workpiece 16 without extensive retooling or recalibration of measurement devices. That is, the measurement tool 10, 110 and measurement system 12, 112 are versatile since the C-shaped body 22 is configured to receive and attach to various calibrated measurement devices 18. Further, the measurement tool 10, 110 and measurement system 12, 112 may be useful for sensing the thickness 14 of the workpiece 16 in various locations 62 on the workpiece 16. The measurement tool 10, 110 and measurement system 12, 112 may therefore allow for in-situ, impromptu thickness 14 measurement and verification for prototyping and research and development activities.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A measurement tool comprising:
a C-shaped body including:
a first arm having a first end;
a second arm spaced apart from and disposed substantially parallel to the first arm; and
a third arm connecting and disposed substantially perpendicular to the first arm and the second arm to thereby define a void between the first arm and the second arm; and
a fourth arm connected to the C-shaped body at the first end and disposed substantially perpendicular to both the first arm and the third arm.

2. The measurement tool of claim 1, further including a plurality of support blocks each spaced apart from the first arm.

3. The measurement tool of claim 2, wherein the plurality of support blocks are repositionable adjacent the first arm and are configured to support a workpiece disposed within the void.

4. The measurement tool of claim 2, wherein the plurality of support blocks are disposed on opposite sides of the first arm.

5. The measurement tool of claim 1, wherein the second arm has a second end spaced apart from the first end and the third arm.

6. The measurement tool of claim 5, wherein the first end and the second end are each configured for attaching to a calibrated measurement device.

7. The measurement tool of claim 1, wherein the first arm is spaced apart from the second arm by from 5 mm to 100 mm.

8. The measurement tool of claim 1, wherein the first arm, the second arm, the third arm, and the fourth arm are integrally formed.

9. A measurement system comprising:
a measurement tool including:
a C-shaped body including:
a first arm having a first end;
a second arm spaced apart from and disposed substantially parallel to the first arm; and
a third arm connecting and disposed substantially perpendicular to the first arm and the second arm to thereby define a void between the first arm and the second arm; and
a fourth arm connected to the C-shaped body at the first end and disposed substantially perpendicular to both the first arm and the third arm; and
a workpiece disposed within the void between the first arm and the second arm.

10. The measurement system of claim 9, wherein the workpiece has a thickness of from 1 mm to 100 mm.

11. The measurement system of claim 10, wherein the workpiece has a width of from 1 mm to 700 mm.

12. The measurement system of claim 9, further including a plurality of support blocks each spaced apart from the first arm.

13. The measurement system of claim 12, wherein the plurality of support blocks are disposed on opposite sides of the first arm.

14. The measurement system of claim 13, wherein the workpiece rests upon and is supported by the plurality of support blocks.

15. The measurement system of claim 9,
wherein the first end is spaced apart from the third arm; and
wherein the second arm has a second end spaced apart from the first end.

16. The measurement system of claim 15, further including a caliper measurement device attached to the first end and the second end and configured for measuring a thickness of the workpiece.

17. The measurement system of claim 16, wherein the workpiece is repositionable within the void such that the caliper measurement device is configured for measuring the thickness of the workpiece in a plurality of locations on the workpiece.

18. A vehicle including the workpiece of the measurement system of claim 9.

19. A measurement system comprising:
a measurement tool including:
a C-shaped body including:
a first arm having a first end;
a second arm spaced apart from and disposed substantially parallel to the first arm, wherein the second arm has a second end spaced apart from the first end; and
a third arm connecting and disposed substantially perpendicular to the first arm and the second arm to thereby define a void between the first arm and the second arm; and
a fourth arm connected to the C-shaped body at the first end and disposed substantially perpendicular to both the first arm and the third arm;
an extension member attached to the second end and configured for extending a length of the second arm; and
a receptacle defining a pocket and attached to the fourth arm; and
a workpiece disposed within the void between the first arm and the second arm.

20. The measurement system of claim 19, further including at least one calibrated laser measurement device configured for measuring a thickness of the workpiece;
wherein the at least one calibrated laser measurement device is attached to the extension member or disposed within the pocket; and
wherein the workpiece is repositionable within the void such that the at least one calibrated laser measurement device is configured for measuring the thickness of the workpiece in a plurality of locations on the workpiece.
